(19) United States
(12) Patent Application Publication
(10) Pub. No.: US 2014/0297055 A1
(43) Pub. Date: Oct. 2, 2014

(54) POWER LEVELING CONTROL DEVICE AND POWER LEVELING CONTROL METHOD

(71) Applicant: FUJITSU LIMITED, Kawasaki-shi (JP)

(72) Inventor: Toshiaki FUNAKUBO, Kawasaki (JP)

(21) Appl. No.: 14/302,979

(22) Filed: Jun. 12, 2014

Related U.S. Application Data
(63) Continuation of application No. PCT/JP2011/079926, filed on Dec. 22, 2011.

(51) Int. Cl. G05F 1/66

(52) U.S. Cl. CPC G05F 1/66
USPC 700/295

(57) ABSTRACT

The processor treats, as a maximum charging amount, a sum of a charging amount with which the power storage device is currently being charged and power or a power amount corresponding to a portion of the power measured or the power amount in the units of time measured that is lower than a smaller value between a maximum value of power or a maximum value of the power amount per unit of time supplied from the power supply measured at or after a past first time point.

The processor supplies power from the power supply to the load and charges the power storage device within a scope such that the maximum charging amount is not exceeded when the measured power or power amount is equal to or lower than the target value, and supply power from the power storage to the load when the target value has been exceeded.

### CROSS-REFERENCE TO RELATED APPLICATION

This application is a continuation application of International Application PCT/JP2011/079926 filed on Dec. 22, 2011 and designated the U.S., the entire contents of which are incorporated herein by reference.

### FIELD

The embodiments discussed herein are related to a power leveling control device and a power leveling control method.

### BACKGROUND

Demand for power varies depending on various factors. Accordingly, electric power equipment is usually designed on the basis of the peak of demand so that it will operate normally even when the demand for power is at maximum. In view of environmental issues or cost issues, electric power equipment such as this utilizes a power storage device so as to meet demand by using stored power when the demand is high and to perform leveling by storing power in the power storage device when demand is low in order to lower the peak of demand for power. When it is possible to lower the peak of demand for power and to perform leveling of variations in the demand, the demand burden ratio, such as that in power generation in an operation form in which output variations are performed as least often as possible, is improved, leading to a higher possibility of reductions in carbon-dioxide (CO₂) emissions and reductions in cost.

In leveling control that utilizes a power storage device, an output target value is sometimes set so that when the demand for power for a load is lower than the output target value, a power storage device is charged with redundant power, and when the demand for power is higher than the output target value, the insufficient portion is discharged from the power storage device.

For example, a system is known that includes a commercial power supply, a power storage device, a converter for converting commercial power supply outputs into direct-current power, and an inverter for converting the converter outputs and the power storage device outputs into stable alternating-current power so as to supply power to a load. In this system, the alternating-current output power of the commercial power supply is measured so that the operations of the converter are halted and the alternating-current output from the inverter that receives power from the power storage device is supplied to a load during a period of time in which the alternating-current output power is higher than a prescribed target value. This control aims to provide an alternating-current supply system that does not allow an amount of power supplied to a load to exceed a prescribed value and that is financially effective.

Patent Document 1: Japanese Laid-open Patent Publication No. 2003-299247

### SUMMARY

According to an aspect of the invention, a power leveling device, on the basis of a prescribed target value, leveling on power supplied by a power supply or a power amount per unit of time in a system in which the power supply is connected with a power storage device and a load comprises a processor. The processor measures power supplied from a power supply or a power amount in units of time supplied from a power supply and to storage the power or the power amount. The processor treats, as a maximum charging amount with which the power storage device is permitted to be charged, a sum of a charging amount with which the power storage device is currently being charged and power or a power amount corresponding to a portion of the power measured or the power amount in the units of time measured that is lower than a smaller value between a maximum value of power supplied from the power supply measured at or after a past first time point or a maximum value of the power amount per unit of time supplied from the power supply measured at or after a past first time and the target value.

The processor also supplies power from the power supply to the load and charges the power storage device within a scope such that the maximum charging amount is not exceeded when the measured power or power amount is equal to or lower than the target value, and discharges the power storage device so as to supply power to the load when the target value has been exceeded.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of a power leveling system according to a first embodiment;

FIG. 2 is a view illustrating power leveling control according to the first embodiment;

FIG. 3 illustrates an example of power leveling control according to the first embodiment;

FIG. 4A is a flowchart illustrating operations of the power leveling system according to the first embodiment;

FIG. 4B is a flowchart illustrating operations of the power leveling system according to the first embodiment;

FIG. 4C is a flowchart illustrating operations of the power leveling system according to the first embodiment;

FIG. 5 explains leveling effects according to the first embodiment and illustrates an example of a result in a case without charge limitations;

FIG. 6 explains leveling effects according to the first embodiment and illustrates an example of a result in a case with charge limitations;

FIG. 7 is a table illustrating the leveling effects according to the first embodiment;

FIG. 8 is a flowchart illustrating operations of a power leveling system according to a second embodiment; and

FIG. 9 is a hardware configuration diagram of a standard computer.

### DESCRIPTION OF EMBODIMENTS

In the above described system, charging of power is not performed during a daytime even when demand for power is lower than a leveling target value. Also, in a case where demand for power has increased suddenly so that a specified leveling target value is too low, discharging of power that exceeds the amount of stored power makes the remaining power zero. In such a case, when a converter is activated in order to prevent a load from stopping, charging of an electric cell is also started. Also, by contrast, when the leveling target value is too high, charged power supplied from a power supply while the cell is being charged is received in addition to load power as long as the alternating-current output power of a commercial power supply does not exceed the target value. In either case, accordingly, the amount made of the peak of load power and charged power becomes the peak of the amount of supplied power, and performing leveling control sometimes leads to a peak increase.

### First Embodiment

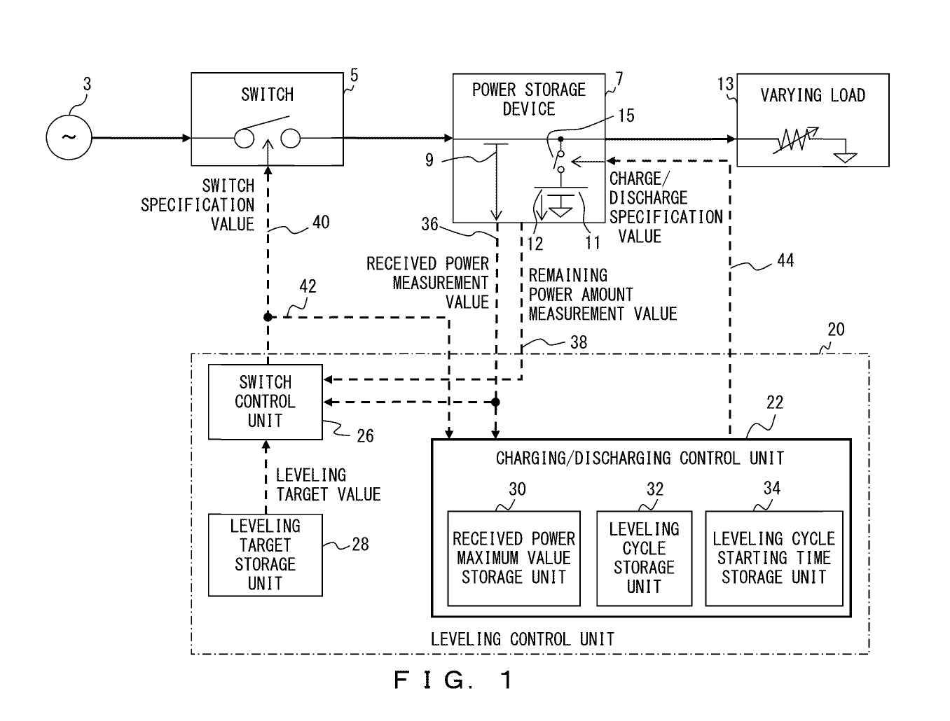

Preferred embodiments of the present invention will be explained with reference to accompanying drawings. First, a configuration of a power leveling system 1 and an outline of power leveling control according to a first embodiment will be explained. FIG. 1 illustrates a configuration of the power leveling system 1 according to the first embodiment. The power leveling system 1 has a power storage device 7 and a varying load 13 connected to a power supply 3 via a switch 5 and includes a leveling control unit 20 for controlling the connection between the power supply 3 and the power storage device 7 to the varying load 13.

The power supply 3 is a commercial power supply. The switch 15 is connected between the power supply 3, the power storage device 7 and the varying load 13 in such a manner that it may open and close so that the connection between the power supply 3, the power storage device 7 and the varying load 13 is switched via an opening and closing of the connection via control by the leveling control unit 20.

The power storage device 7 is connected to the switch 5 and the varying load 13, and includes a received power measurement unit 9, a switch 15, an electric cell 11 and a remaining power amount measurement unit 12. The received power measurement unit 9 measures power received from the power supply 3, and outputs the measurement to the leveling control unit 20. The switch 15 is controlled by the leveling control unit 20 so as to switch the connection between the electric cell 11 and the switch 15 and the varying load 13. The electric cell 11 charges part of the power received from the power supply 3 or supplies power to the varying load 13 by discharging the charged power in accordance with whether the switches 5 and 15 are open or closed. The remaining power amount measurement unit 12 measures power remaining in the electric cell 11, and outputs the measurement result to the leveling control unit 20.

The varying load 13 is a load whose power consumption varies, such as a home or a company. In FIG. 1, when the output of the power supply 3, the input and the output of the electric cell 11, and the input of the varying load 13 do not conform with each other in view of whether they are for direct-current power or alternating-current power, a DC/AC converter is inserted appropriately.

The leveling control unit 20 includes a charging/discharging control unit 22, a switch control unit 26, and a leveling target storage unit 28. The charging/discharging control unit 22 includes a received power maximum value storage unit 30, a leveling cycle storage unit 32, and a leveling cycle starting time storage unit 34, and outputs an operation signal for controlling the charging/discharging of the electric cell 11 as depicted by arrow 44 on the basis of respective values stored in these units, values obtained by the received power measurement unit 9 and the electric cell remaining power amount measurement unit 12, and an operation signal output from the switch control unit 26 for controlling the switch 15 (which will be described later). Further, the leveling control unit 20 includes a leveling cycle timer, a demand term timer, and a monitor control cycle timer (these timers are not illustrated) so as to manage the respective cycles.

A leveling cycle timer in this example is a clock device that manages leveling cycle T0, which is defined as a cycle in which for example a period with a high power demand of the varying load 13 and a period with a low power demand of the varying load 13 are expected to occur alternately. Leveling cycle T0 may be for example one day (24 hours) in which daytime demand is high and nighttime demand is low. A demand term timer is a clock device managing demand term T1 that integrates the received power for determining the power amount per unit of time from the power supply 3. A monitor control cycle timer is a clock device that manages a monitoring time for measuring the power received from the power supply 3.

The switch control unit 26 outputs an operation signal for controlling the switch 15 as depicted by arrows 40 and 42 on the basis of values obtained by the received power measurement unit 9 and the remaining power amount measurement unit 12 and a leveling target value stored in the leveling target storage unit 28. The leveling target storage unit 28 beforehand obtains and stores a leveling target value. The received power maximum value storage unit 30 stores a received power maximum value that is in accordance with losses or the like in the varying load 13 and the electric cell 11. The leveling cycle storage unit 32 stores leveling cycle T0. The leveling cycle starting time storage unit 34 stores a starting time t0 of a leveling cycle.

The leveling target storage unit 28, the received power maximum value storage unit 30, the leveling cycle storage unit 32, and the leveling cycle starting time storage unit 34 are rewritable memories such as for example Random Access Memories (RAMs) or the like. It is also possible to store a program for controlling operations of the leveling control unit 20 in a RAM.

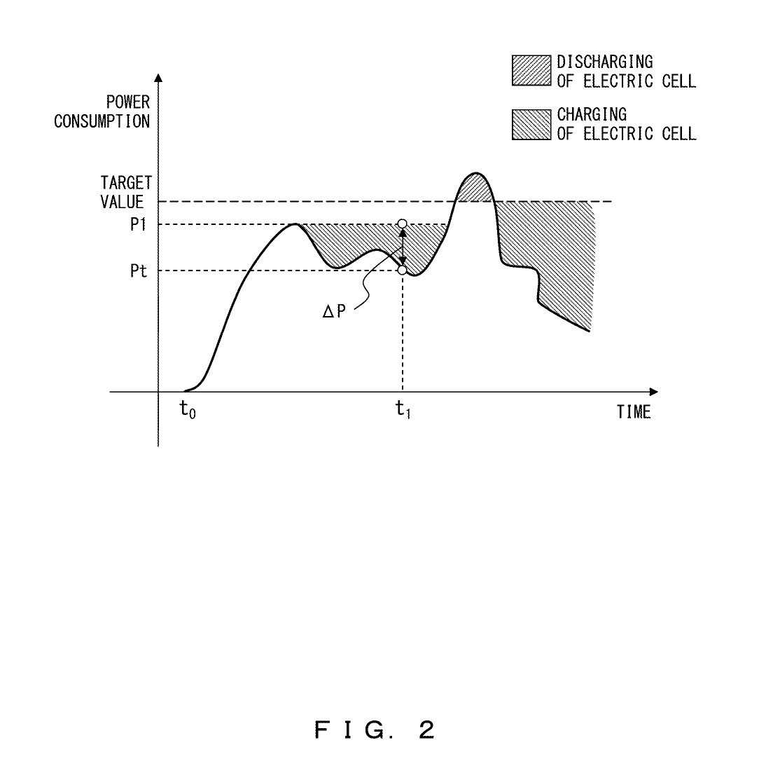

FIG. 2 is a view illustrating power leveling control according to the first embodiment with the vertical axis representing the power consumption of a load and the horizontal axis representing time. As illustrated in FIG. 2, when the power consumption is higher than the target value, the electric cell 11 is discharged so that the electric cell 11 supplies power to the varying load 13. When the power consumption is lower than the target value, the electric cell 11 is charged in such a manner that the difference between the current power consumption and the lower value between the maximum power consumption after a particular point in time in the past and the target value is not exceeded. Thereby, a power ΔP that is lower than the lower value between current power consumption Pt, maximum value P1 of power consumption for example from a starting time t0 of leveling cycle T0 to the present, and the target value of the leveling control is the maximum storage amount with which the electric cell 11 will be charged. Note that the target value of power consumption may be a power amount per unit of time.

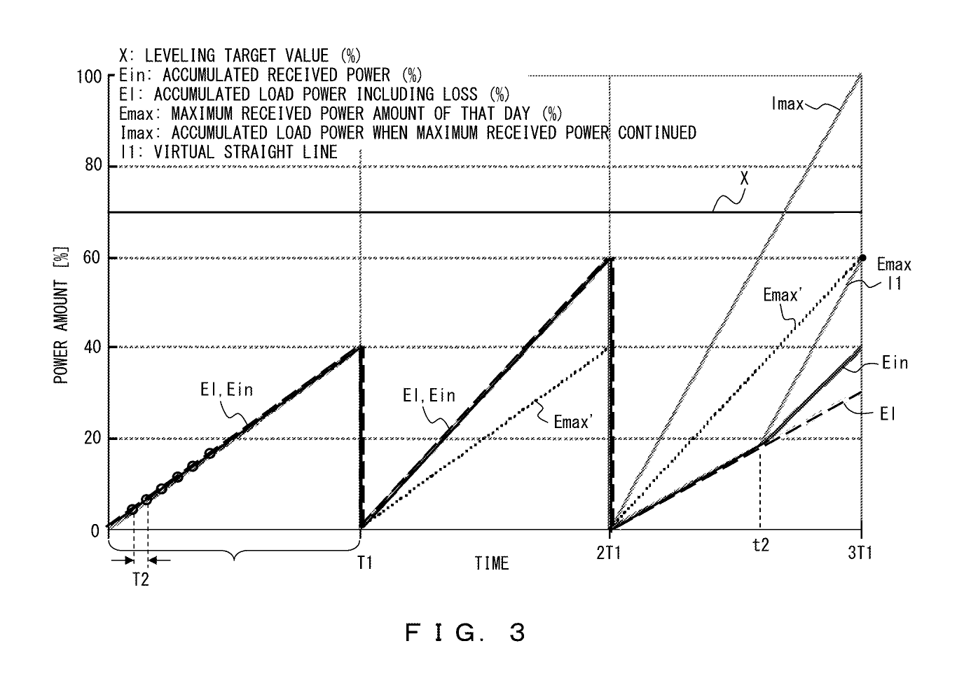

FIG. 3 illustrates an example of power leveling control with the vertical axis representing the ratio of a power consumption amount to the maximum power amount that the varying load 13 will consume per demand term T1 and the horizontal axis representing time. FIG. 3 illustrates temporal changes in accumulated received power Ein and accumulated load power El of the varying load 13. Accumulated received power Ein is an amount of power accumulated during a period of time that has elapsed since the start of demand term T1 on an assumption that the received power measured by the received power measurement unit 9 will continue for monitoring time T2. Accumulated load power El is an amount of power consumed by the varying load 13 during a period of time that elapsed since the start of demand term T1. Maximum accumulated power Emax′ represents a variation in the maximum accumulated received power in corresponding leveling cycle T0 during Demand term T1. Target value x is a target value of leveling control and is a value used so that the electric cell 11 is discharged in order to prevent an increase in the power received from the power supply 3 when the amount of power received from the power supply 3 during demand term T1 has exceeded leveling target value x.

In power leveling control according to the present embodiment, for example the total amount of power received from the power supply 3 during prescribed demand term T1, is measured for each monitoring time T2, and the reception of power from the power supply 3 is controlled on the basis of a comparison between measured accumulated received power Ein and leveling target value x. Even in a case where accumulated received power Ein is smaller than leveling target value x and the varying load 13 or the like continues the maximum power consumption during a period of time before the start of the next demand term, the electric cell 11 is charged only when it is definitely determined that the maximum value of the received power amount per past demand term T1 in corresponding leveling cycle T0 will not be exceeded.

As illustrated in FIG. 3, when the power consumption amount of the varying load 13 varies like accumulated load power El between time 0 and time T1, the electric cell 11 is not charged even when accumulated received power Ein does not reach leveling target value x because maximum accumulated power Emax′ is zero. Between time T1 and time 2T1, because accumulated received power Ein has exceeded maximum accumulated power Emax′ based on the maximum received power amount between time 0 and time T1, the electric cell 11 is not charged even when accumulated received power Ein does not reach leveling target value x.

Between time 2T1 and time 3T1, accumulated received power Ein has fallen below maximum accumulated power Emax′ based on the maximum received power amount between time T1 and time 2T1 and accumulated received power Ein does not reach level target value x. However, even in a case where the varying load 13 or the like continues the maximum power consumption until time 3T1, at which current demand term T1 terminates, and the charged power in case of charging the electric cell 11 maintains the maximum value, the electric cell 11 is charged only when it is definitely determined that the maximum value of a past accumulated received power amount in corresponding leveling cycle T0 will not be exceeded. In other words, even when accumulated received power Ein has increased in a virtual straight line 11 having an inclination parallel to accumulated received power lmax in a situation continuing where the power consumption in the varying load 13, the power with which the electric cell 11 is charged, and the power loss occurring in the system become the maximum, the electric cell 11 is charged at and after time t2 when maximum received power amount Emax in the corresponding leveling cycle is not exceeded. As a result of this, in the example in FIG. 3, accumulated received power Ein is assumed to exceed accumulated load power El, whereas it does not exceed maximum received power amount Emax.

When the electric cell 11 is charged, the switches 5 and 15 are in a closed state. When the electric cell 11 is charged, the switch 5 is opened and the switch 15 is in a closed state. When the electric cell 11 is neither charged nor discharged and the power supply 3 supplies power to the varying load 13, the switch 5 is closed while the switch 15 is opened. Note that accumulated received power Ein is reset each time respective demand terms T1 start, and accordingly the switch 5 is closed and the switch 15 is in an open state. As described above, power leveling control is performed so that the received power amount per demand term is limited to a value equal to or smaller than leveling target value x and the maximum load power amount per demand term in corresponding leveling cycle T0 is not exceeded.

In the power leveling system 1 as described above, even when the amount of power received from the power supply 3 is equal to or smaller than leveling target value x, charging is performed only when it is determined that the maximum load power amount that has occurred between a past reference time to the present (for example the peak load power amount of today) is not exceeded. This determination is expressed as in expression 1 below.

Current accumulated received power+(maximum load power+maximum charged power+maximum loss power)×remaining demand term≦maximum received power amount per demand term in leveling cycle (expression 1).

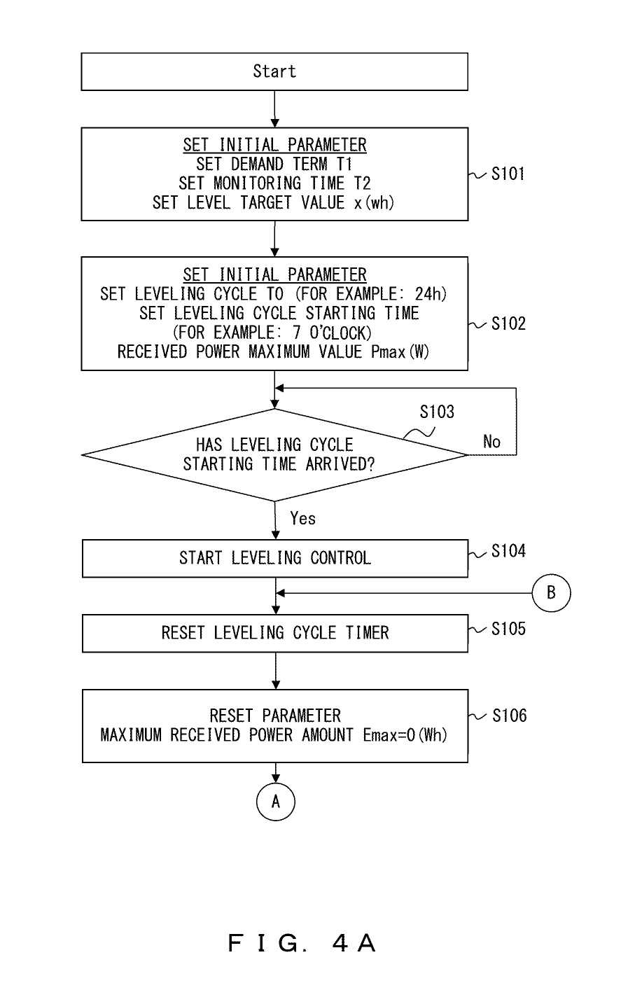

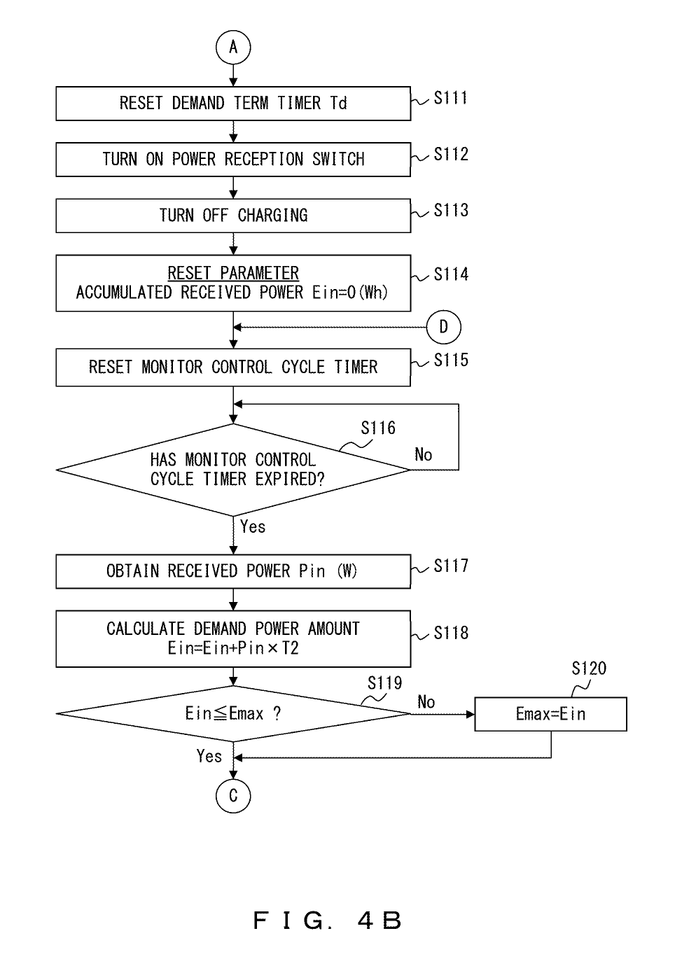

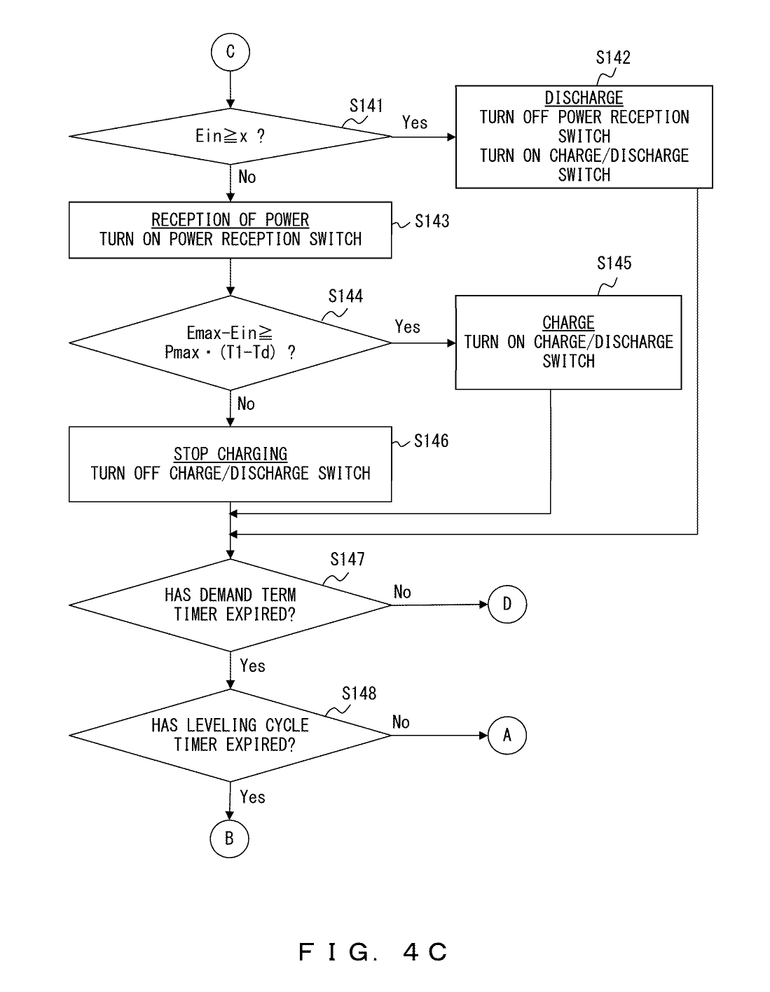

Hereinbelow, operations of the power leveling system 1 will be explained by referring to FIG. 4A through FIG. 4C. FIG. 4A through FIG. 4C are flowcharts illustrating operations of the power leveling system 1 according to the first embodiment.

As illustrated in FIG. 4A, in the charging/discharging control unit 22, an initial parameter setting of power leveling control is performed beforehand. In other words, demand term T1, monitoring time T2, and leveling target value x (Wh) are set (S101). Leveling target value x may be set by reading a value beforehand stored in the leveling target storage unit 28. Also, in the charging/discharging control unit 22, leveling cycle T0 (for example, 24 hours), a leveling cycle starting time (for example, 7 o'clock AM), and received power maximum value Pmax (W) are set (S102). Received power maximum value Pmax is a maximum power that may be received from the power supply 3 including the maximum power consumption in the varying load 13, the maximum charged power in the electric cell 11, and losses in the varying load 13 and the like. Set parameters are stored in the leveling cycle storage unit 32, the leveling cycle starting time storage unit 34, and the received power maximum value storage unit 30, respectively.

The leveling control unit 20 monitors whether or not the leveling cycle starting time set in S102 has arrived by comparing a leveling cycle timer (not illustrated) and a leveling cycle starting time stored in the leveling cycle starting time storage unit 34 until the leveling cycle starting time arrives (NO in S103). When the leveling cycle starting time has arrived (YES in S103), the leveling control unit 20 starts leveling control (S104). In other words, the leveling control unit 20 resets a leveling cycle timer (not illustrated) (S105). The charging/discharging control unit 22 resets maximum received power amount Emax to zero (Wh) (S106).

The process proceeds to the process in FIG. 4B, where the leveling control unit 20 resets the demand term timer (not illustrated) (Td=0) (S111). In this example, time Td is a time based on the starting time of each demand term. The switch control unit 26 outputs a switch specification value for closing the switch 5 and starting the reception of power as depicted by arrow 40, and the switch 5 closes the connection in accordance with a switch specification value from the switch control unit 26 (S112). Also, when this is performed, the switch control unit 26 outputs a switch specification value to the charging/discharging control unit 22, and the charging/discharging control unit 22 refers to the switch specification value, the demand term timer, etc., outputs a charge/discharge specification value to the switch 15 as depicted by arrow 44, and disconnects the connection. When this is performed, the electric cell 11 is electrically disconnected from the power supply 3 and the charging is turned off (S113).

Further, the leveling control unit 20 resets accumulated received power Ein to zero (Wh) (S114) and resets the monitor control cycle timer (not illustrated) (S115). The leveling control unit 20 continues monitoring until the monitor control cycle timer expires (NO in S116), and upon the expiration (YES in S116), it obtains received power Pin (W) by using the received power measurement unit 9 (S117) and calculates accumulated received power Ein=Ein+Pin×T2 (S118). The leveling control unit 20 compares accumulated received power Ein and maximum received power amount Emax. When accumulated received power Ein maximum received power amount Emax is not satisfied (i.e., when accumulated received power Ein>maximum received power amount Emax is satisfied) (NO in S119), the charging/discharging control unit 22 replaces it with maximum received power amount Emax=accumulated received power Ein (S120), and the process proceeds to the process in FIG. 4C. When accumulated received power Ein maximum received power amount Emax is satisfied (YES in S119), the process proceeds to the process in FIG. 4C.

As illustrated in FIG. 4C, the switch control unit 26 compares accumulated received power Ein and leveling target value x (S141). When accumulated received power Ein leveling target value x is satisfied (YES in S141), the switch control unit 26 outputs a switch specification value for disconnecting the switch 5 and the switch 5 turns off the electric connection with the power supply 3, the power storage device 7, and the varying load 13. At the same time, the switch control unit 26 outputs a switch specification value to the charging/discharging control unit 22 and the charging/discharging control unit 22 refers to the fact that the switch specification value is OFF and outputs a charge/discharge specification value as ON to the switch 15. Thereby, the switch 15 is turned on, the varying load 13 and the electric cell 11 are connected electrically, and the electric cell 11 is discharged (S142). Thereafter, the leveling control unit 20 makes the process proceed to S147. When accumulated received power Ein leveling target value x is not satisfied (NO in S141), the switch control unit 26 outputs a switch specification value for connecting the switch 5. The switch 5 turns on the electric connection with the power supply 3, the power storage device 7, and the varying load 13 (S143).

The charging/discharging control unit 22 turns on the charging (S145) when maximum received power amount Emax−accumulated received power Ein≧received power maximum value Pmax×(demand term T1-time Td) (=expression 1) is satisfied and charging is possible while power is being received (YES in S144). Specifically, the charging/discharging control unit 22 outputs a charge/discharge specification value that turns on the connection to the switch 15 when it refers to a switch specification value and it is ON.

When maximum received power amount Emax−accumulated received power Ein<received power maximum value Pmax×(demand term T1-time Td) is satisfied and the discharging is not being performed while power is being received (NO in S144), the charging/discharging control unit turns off the charging (S146). Specifically, the charging/discharging control unit 22 outputs a charge/discharge specification value that turns off the connection to the switch 15 when it refers to a switch specification value and it is ON.

While the leveling control unit 20 determines that the demand term timer has not expired (NO in S147), the processes from S115 in FIG. 4B through S147 in FIG. 4C are repeated. When the leveling control unit 20 has determined that the demand term timer has expired (YES in S147), it determines whether or not the leveling cycle timer has expired (S148). While the leveling control unit 20 determines that the leveling cycle timer has not expired (NO in S148), the processes from S111 in FIG. 4B through S148 in FIG. 4C are repeated. When the leveling control unit 20 has determined that the leveling cycle timer has expired (YES in S148), it repeats the processes from S105 in FIG. 4A.

Leveling target value x in the power leveling system according to the first embodiment, having the above configuration, is defined beforehand by using an arbitrary method and is stored in the leveling target storage unit 28. In power leveling control as described above, feedback control may be performed for updating future leveling target value x on the basis of results of controlling past leveling cycles.

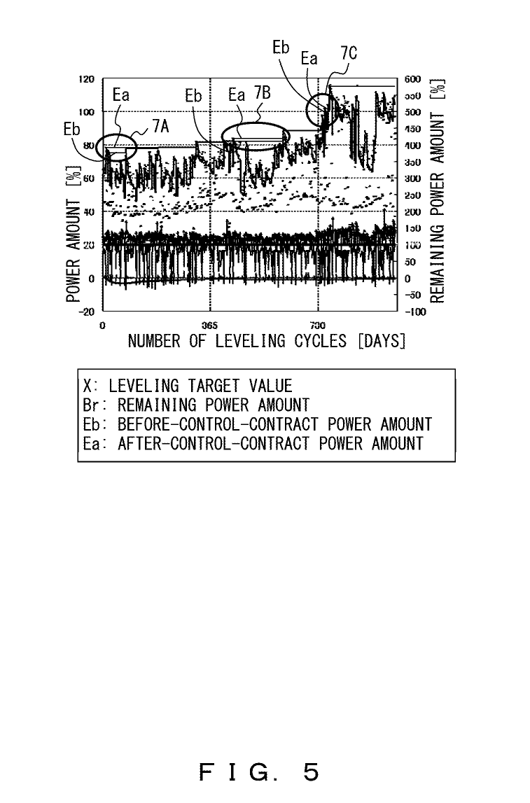

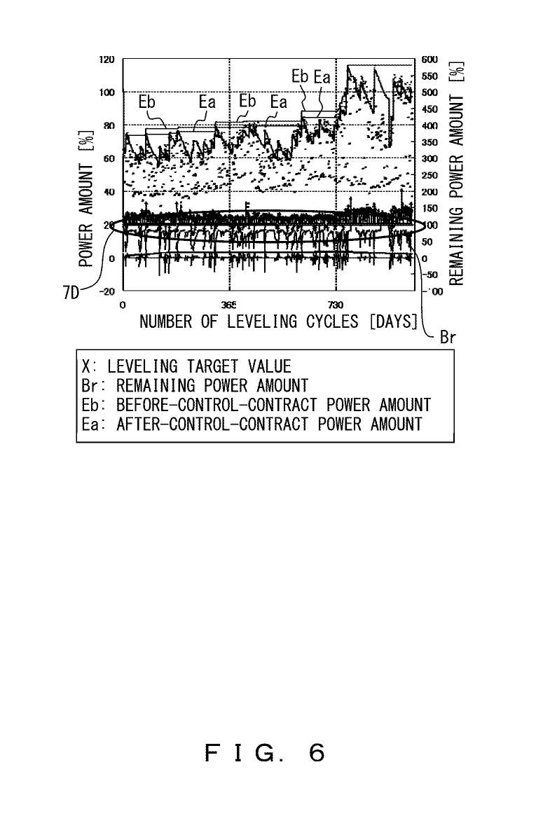

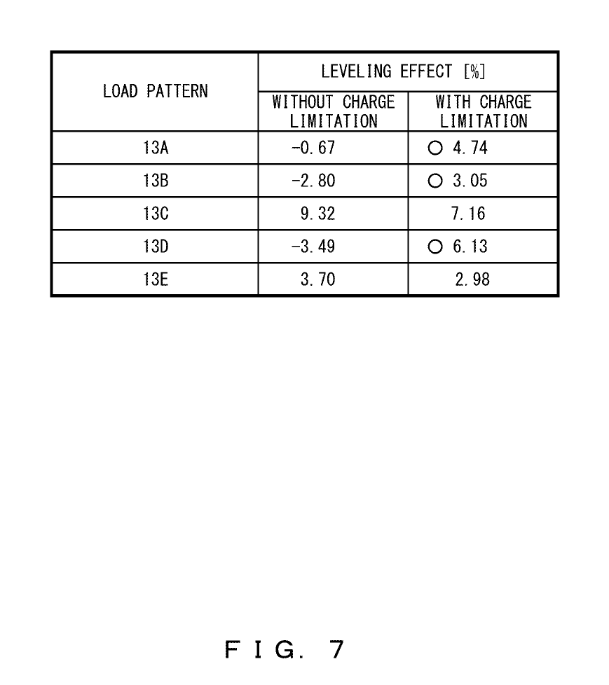

By referring to FIG. 5, FIG. 6, and FIG. 7, explanations will be given for an example of a result of imposing a charge limitation by using expression 1 as in the above power leveling system 1. FIG. 5 and FIG. 6 explain leveling effects according to the present embodiment and illustrate examples of results of power leveling control in cases when a charge limitation is imposed and a charge limitation is not imposed. The vertical axis represents the ratio of a power amount to the maximum power amount that the varying load 13 will consume per unit of time and also represents the ratio of remaining power amount Br to the capacity of the electric cell 11. The horizontal axis represents time.

FIG. 5 and FIG. 6 illustrate after-control-contract power amount Ea, which is the maximum value of accumulated received power Ein in the past 365 leveling cycles, before-control-contract power amount Eb, which is the maximum value of the maximum load power amount per demand term in the past 365 leveling cycles, and leveling target value x. In addition to these, the peak value in a leveling cycle of accumulated received power Ein, the minimum value of the remaining amount of the electric cell 11, etc., are also illustrated; however, this example focuses on leveling target value x, remaining power amount Br in leveling cycles, before-control-contract power amount Eb, and after-control-contract power amount Ea.

FIG. 5 illustrates an example of a case where a leveling control that charges the electric cell 11 without charge limitations was performed when accumulated received power Ein was smaller than leveling target value x. FIG. 6 illustrates an example of a case where leveling control with a charge limitation according to the present embodiment was performed. Also, the fact that leveling control is not performed means that all power to be supplied to the varying load 13 is supplied from the power supply 3 without using the electric cell 11.

As illustrated in FIG. 5, when a charge limitation is not imposed, after-control-contract power amount Ea exceeds before-control-contract power amount Eb as in areas 7A, 7B, and 7C. However, as depicted in area 7D in FIG. 6, when a charge limitation according to the present embodiment is imposed, a contract power amount does not exceed a case when a leveling control is not performed even though a total remaining amount is smaller than the case of FIG. 5 as depicted by remaining power amount Br. In other words, after-control-contract power amount Ea≦before-control-contract power amount Eb is satisfied. In the examples illustrated in FIG. 5 and FIG. 6, feedback control is performed on leveling target value x on the basis of remaining power amount Br; however, because the same methods are used and no substantial effects are expected when they are compared, detailed explanations will be omitted.

FIG. 7 is a table illustrating ratios of leveling effects to cases without leveling control in cases when leveling control is performed for a plurality of types of variable loads 13A through 13E for cases with a charge limitation and without charge limitations. The ratios of leveling effects are calculated on the basis of a value obtained by integrating contract power amounts of respective days for each condition for the same period (for example approximately three years). Note that for convenience of explanation, positive values represent leveling effects when effects are confirmed (i.e., when the total amount of contract power amounts is small).

In FIG. 7, in a case when charge limitations are imposed, fields with circles represent that effects are confirmed in comparison with cases without charge limitations.

As illustrated in FIG. 7, although leveling effects with a charge limitation are not always higher for all types of loads, in regard to leveling effects without a charge limitation, there are three types of cases where effects are lower than cases without leveling control (i.e., cases when the leveling effects are negative) However, when a charge limitation is imposed as in the present embodiment, the leveling effects are higher (positive values) in at least all the cases illustrated in FIG. 7 than when no charge limitations are imposed so that the effects of charge limitations will be recognized.

As described above, according to the power leveling system 1 of the first embodiment, a charge limitation is imposed when leveling control is performed on leveling target value x. Accordingly, the switch 15 is provided and the connection between the power supply 3 and the electric cell 11 is controlled separately from the connection between the power supply 3 and the varying load 13. In other words, it is possible by using the switches 5 and 15 to perform switching between a first state where power is supplied to the varying load 13 by discharging the electric cell 11, a second state where power is supplied to the varying load 13 from the power supply 3, and a third state where power is supplied to the varying load 13 from the power supply 3 and the electric cell 11 is charged.

In the first embodiment, a sum is calculated between accumulated received power Ein in the corresponding demand term at the present, an amount of power needed when the maximum load power (including losses) is maintained in the remaining period of time in the present demand term, and maximum charged power (including charging losses) x monitoring time T2. Upon this, the charging of the electric cell 11 is permitted only when the calculated sum is equal to or smaller than maximum received power amount Emax in current leveling cycle TO.

Thereby, the electric cell 11 is charged only when it is certain that the smaller value between the maximum value of values of accumulated received power Ein since the start of leveling cycle T0 to the present and leveling target value x will not be exceeded. In other words, control is performed so that maximum received power amount Emax in the current leveling cycle will not be exceeded even when the electric cell 11 is charged until the end of the current demand term.

As described above, according to the power leveling system 1, because discharging is performed only when a target value has been exceeded even during the daytime, it is possible to utilize power stored in the electric cell 11 more effectively than for example in peak shift control, which performs discharging during the daytime and performs charging during a nighttime.

Also, in a power leveling system, while it is possible to some extent to determine a leveling target value by prediction, estimation, modeling, etc., complete foreknowledge is not possible, leading to “too high/too low” target values. When leveling target value x is too low, the power storage device becomes empty, sometimes leading to a situation where charged power is added to accumulated received power Ein upon re-charging so as to raise the peak (negative effect). When leveling target value x is too high, charged power is added to the load power in a case when it is equal to or smaller than leveling target value x, sometimes leading to a situation where the peak of accumulated received power Ein is raised. However, the use of the charge limitation according to the present embodiment will prevent at least the negative effects, making it possible to enhance the performance of leveling control.

Because contract power is determined on the basis of the maximum accumulated received power in the previous one year as a general rule, even when the peak has increased for a period of 30 minutes only once in the 365 days due to a “too high/too low” target value, effects thereof continue to the term for determining the contract power. However, in the present embodiment, a charge limitation is imposed, and accordingly, making it possible to prevent the maximum received power amount from exceeding a past maximum received power amount in the corresponding leveling cycle by charging the electric cell 11 without limitations. Accordingly, the leveling effects will be enhanced by preventing a peak increase (negative effects) due to leveling control and highly efficient leveling control is possible even when leveling target value x is not set appropriately.

Further, by setting the starting time of a leveling cycle immediately before a term with a high demand for power, the number of terms with load-consumed power that fall below the maximum received power since the start of a leveling cycle increases. This increases opportunities for performing charging.

### Second Embodiment

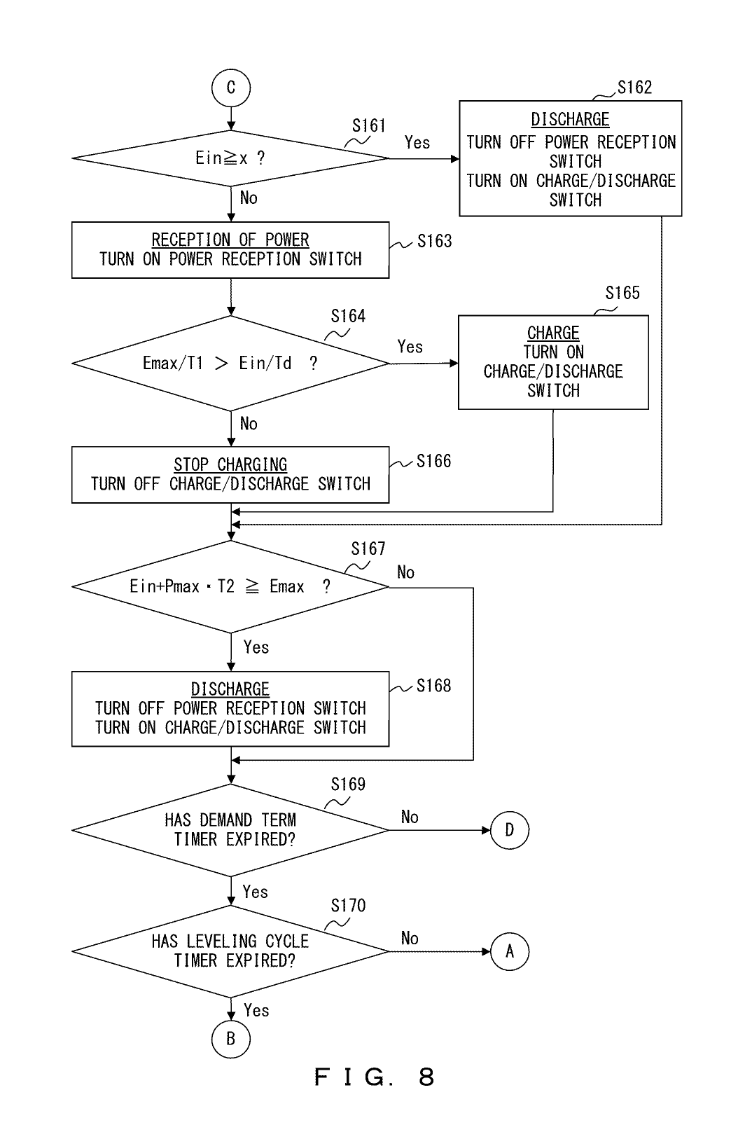

Hereinafter, by referring to FIG. 8, explanations will be given for the power leveling system 1 according to a second embodiment. In the present embodiment, detailed explanations for configurations and operations similar to those in the power leveling system 1 according to the first embodiment will be omitted. The configuration of the power leveling system 1 according to the present embodiment is similar to that of the power leveling system 1 according to the first embodiment.

FIG. 8 is a flowchart illustrating operations of the power leveling system 1 according to the second embodiment. The power leveling system 1 according to the present embodiment performs the operations illustrated in FIG. 4A and FIG. 4B similarly to the power leveling system 1 according to the first embodiment. Thereafter, the operations illustrated in FIG. 8 are performed instead of the operations of the first embodiment illustrated in FIG. 4C.

As illustrated in FIG. 8, the switch control unit 26 compares accumulated received power Ein and leveling target value x (S161). When accumulated received power Ein leveling target value x is satisfied (YES in S161), the switch control unit 26 outputs a switch specification value for disconnecting the switch 5 while the switch 5 turns off the electric connection with the power supply 3, the power storage device 7, and the varying load 13. At the same time, the switch control unit 26 outputs a switch specification value to the charging/discharging control unit 22 while the charging/discharging control unit 22 refers to the fact that the switch specification value is OFF and outputs a charge/discharge specification value as ON. Thereby, the switch 15 is turned on, the varying load 13 and the electric cell 11 are connected electrically, and the electric cell 11 is discharged (S162). Thereafter, the leveling control unit 20 makes the process proceed to S167. When accumulated received power Ein leveling target value x is not satisfied (NO in S161), the switch control unit 26 outputs a switch specification value that connects the switch 5. The switch 5 turns on the electric connection with the power supply 3, the power storage device 7, and the varying load 13 (S163).

The charging/discharging control unit 22 turns on the charging (S165) when maximum received power amount Emax/demand term T1>accumulated received power Ein/time Td is satisfied and charging is possible while charging is being performed (YES in S164). In other words, the charging/discharging control unit 22 outputs a charge/discharge specification value that turns on the connection to the switch 15 and makes the switch control unit 26 output a switch specification value that turns on the switch 5. Then, the leveling control unit 20 makes the process proceed to S167.

When maximum received power amount Emax/demand term T1 accumulated received power Ein/time Td is satisfied (NO in S164), the charging/discharging control unit 22 turns off the charging (S166). In other words, the charging/discharging control unit 22 outputs a charge/discharge specification value that makes the switch 15 turn off the connection, and makes the switch control unit 26 output a switch specification value that turns on the switch 5. Thereafter, the charging/discharging control unit 22 makes the process proceed to S167.

When accumulated received power Ein+received power maximum value Pmax×monitoring time T2 maximum received power amount Emax is satisfied (YES in S167), the charging/discharging control unit 22 makes the switch control unit 26 output a switch specification value that turns off the switch 5 (S168). The charging/discharging control unit 22 makes the switch 15 turn on. Then, the reception of power from the power supply 3 to the varying load 13 is turned off, and the electric cell 11 is discharged. Thereafter, the leveling control unit 20 makes the process proceed to 5169. When accumulated received power Ein+received power maximum value Pmax×monitoring time T2<maximum received power amount Emax is satisfied (NO in S167), the leveling control unit 20 makes the process proceed to 5169.

While the leveling control unit 20 determines that the demand term timer has not expired (NO in S169), the processes in S115 in FIG. 4B through S169 in FIG. 4C are repeated. When the leveling control unit 20 has determined that the demand term timer has expired (YES in S169), it determines whether or not the leveling cycle timer has expired (S170). While the leveling control unit 20 determines that the leveling cycle timer has not expired (NO in S170), the processes in S111 in FIG. 4B through S170 in FIG. 4C are repeated. When the leveling control unit 20 has determined that the leveling cycle timer has expired (YES in S170), the leveling control unit 20 repeats the processes from S105 in FIG. 4A.

Leveling target value x in the power leveling system 1, according to the second embodiment, having the above configuration is defined by an arbitrary method beforehand and is stored in the leveling target storage unit 28. In the above described leveling control, feedback control may be performed for updating a future leveling target value x on the basis of control results of past leveling cycles or the like.

As described above, according to the power leveling system 1 of the second embodiment, a charge limitation is imposed when leveling control is performed on leveling target value x. Accordingly, the switch 15 is provided so as to control the connection between the power supply 3 and the electric cell 11 independently from the connection between the power supply 3 and the varying load 13. In other words, it is possible to perform switching between a first state where power is supplied to the varying load 13 by discharging the electric cell 11, a second state where power is supplied to the varying load 13 from the power supply 3, and a third state where power is supplied to the varying load 13 from the power supply 3 and the electric cell 11 is charged.

Thereby, the electric cell 11 is charged only when a value obtained by averaging present accumulated received power Ein by the period of time between the start of the demand term and the present is lower than a value obtained by averaging maximum received power amount Emax by demand term T1. In other words, the electric cell 11 is charged only when a value obtained by dividing accumulated received power Ein in present demand term T1 by time Td since the start of the demand term is lower than a value obtained by dividing maximum received power amount Emax in leveling cycle T0 by demand term T1. As described above, in the second embodiment, whether or not to perform charging is determined under the above conditions on the basis of a predicted value of the maximum power amount at the end of the corresponding demand term.

When there is a possibility that maximum received power amount Emax in corresponding leveling cycle T0 after monitoring time T2 will be exceeded, the reception of power from the power supply 3 is halted, and the electric cell 11 is discharged. In other words, A value is obtained by multiplying the sum of a maximum load power including losses and the maximum charge power including charging losses by monitoring time T2 and adding the multiplication result to the accumulated received power Ein in present demand term T1. When the calculated sum is equal to or greater than maximum received power amount Emax in present leveling cycle T0, discharging is performed. As described above, according to the power leveling system 1 of the second embodiment, the electric cell 11 is charged even when there is a possibility that a subsequent increase in the power consumed by the varying load 13 will deteriorate the leveling performance. Accordingly, when a possibility of deterioration in the leveling performance has emerged, the switch 5 is turned off and the reception of power from the power supply 3 to the electric cell 11 is halted so as to perform discharging. However, when no power remains in the electric cell 11, the reception of power is not halted and discharging is not performed.

As described above, according to the power leveling system 1 of the second embodiment, because discharging is performed only when a target value has been exceeded, even during the daytime, it is possible to utilize power stored in the electric cell 11 more effectively than for example with peak shift control, which performs discharging during the daytime and performs charging during the nighttime. By imposing the charge limitation according to the present embodiment, it is possible to at least avoid negative effects and to enhance the performance of leveling control.

In the present embodiment, a charge limitation is imposed, and thereby it is possible to avoid negative effects that would be caused when the electric cell 11 is charged without limitations and accumulated received power Ein exceeds maximum received power amount Emax. When it has been determined that maximum received power amount Emax will not be exceeded at the end of demand term T1, because it is a condition for permitting charging, it often occurs that charging is not permitted until around the end of demand term T1 in the first embodiment. In particular, charging is not easily permitted in a case when the variation in accumulated received power Ein is moderate, in the daytime during weekdays, holidays, etc. By contrary to the first embodiment, which is based on an assumption of a worst case, the charge limitation according to the second embodiment is based on an assumption of an average case and the conditions are eased, resulting in more opportunities for charging.

By contrast, in the second embodiment, when there is a possibility that maximum received power amount Emax in the corresponding leveling cycle T0 will be exceeded after monitoring time T2, discharging is performed. Accordingly, opportunities for charging the electric cell are increases while avoiding negative effects.

Thereby, a period of time where there is a small amount of remaining power increases because of the reduction in opportunities for performing charging, and when for example, in a case where the power supply 3 will not receive power, the power supply 3 is shared for backup purposes, it is possible to reduce the possibility of not being able to perform backup and to improve the leveling effects. Further, even when leveling target value x has not been set appropriately, highly efficient leveling control is possible.

In the above first or second embodiment, the leveling control unit 20 is an example of a control unit, the charging/discharging control unit 22 is an example of a maximum charging amount determination unit, and the switches 5 and 15 are examples of a switching unit. The switch control unit 26 is an example of a first switching control unit and the charging/discharging control unit 22 is an example of a second switching control unit. Also, demand term T1 is an example of units of time, and monitoring time T2 is an example of a prescribed period of time.

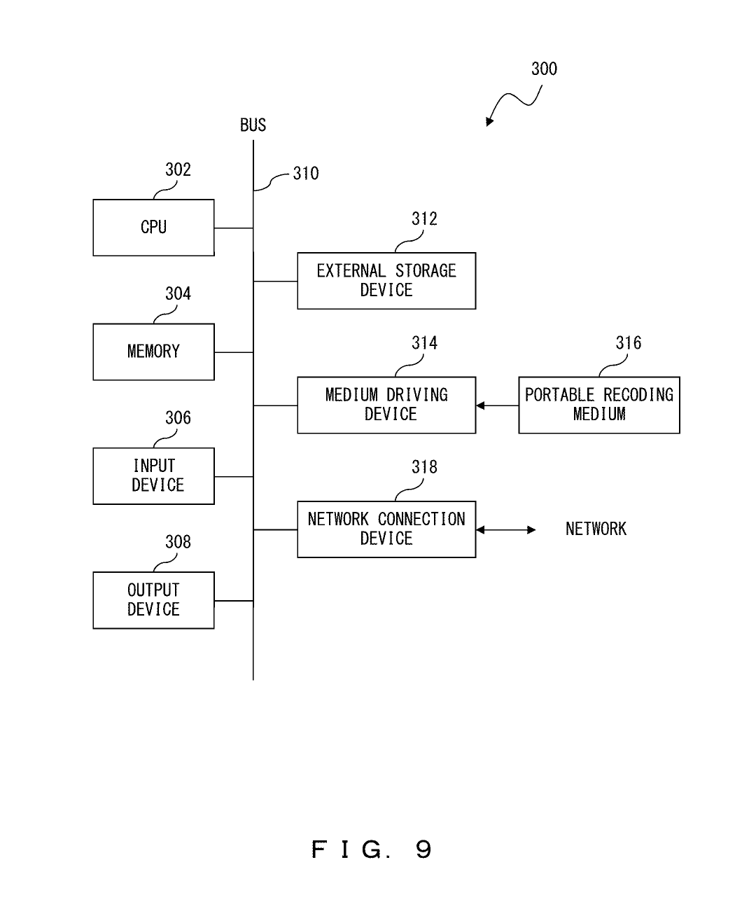

Explanations will be given for an example of a computer that is applied commonly when a computer is to be made to perform the operations of the above power leveling control methods according to first and second embodiments. FIG. 9 is a block diagram illustrating an example of a hardware configuration of a standard computer. As illustrated in FIG. 9, in a computer 300, a Central Processing Unit (CPU) 302, a memory 304, an input device 306, an output device 308, an external storage device 312, a medium driving device 314, a network connection device, and the like are connected via a bus 310.

The CPU 302 is an arithmetic processing device that controls the entirety of the operations of the computer 300. The memory 304 is a storage unit that stores a program for controlling operations of the computer 300 beforehand or that is used as a working area on an as-needed basis when a program is executed. The memory 304 is for example a RAM, read only memory (ROM) or the like. When the input device 306 is manipulated by for example a user of the computer, it obtains inputs of various pieces of information from the user that are associated with the manipulation contents, and transfers the input information to the CPU 302. Examples of the input device 306 are a keyboard device, a mouse device, etc. The output device 308 outputs results of processes performed by the computer 300 and includes a display device or the like. For example, a display device displays a text or an image in accordance with display data transferred by the CPU 302.

The external storage device 312 is a storage device such as a hard disk or the like, and is a device that stores various types of control programs executed by the CPU 302, obtained data, or the like. The medium driving device 314 is a device for performing writing and reading with respect to a portable recording medium 316. The CPU 302 may also read a prescribed control program stored in the portable recording medium 316 via a medium driving device 314 so as to execute various types of control processes. The portable recording medium 316 is for example a Compact Disc (CD)-ROM, a Digital Versatile Disc (DVD), a Universal Serial Bus (USB) memory, or the like. A network connection device 318 is an interface device that manages wired or wireless exchanges of various types of data with respect to an external environment. The bus 310 is a communication path that connects the above various devices or the like so as to permit data exchange.

A program that causes a computer to execute the above power leveling method according to the first or second embodiment is stored in for example the external storage device 312. The CPU 302 reads the program from the external storage device 312 so as to cause the computer 300 to perform operations of power leveling. For this, a control program that causes the CPU 302 to perform the process of power leveling is first generated and is stored in the external storage device 312. Thereafter, a prescribed instruction is given from the input device 306 to the CPU 302 so that it reads that control program from the external storage device 312 to execute it. Also, this program may be stored in the portable recoding medium 316.

According to the power leveling device of the above aspect, it will be a power leveling device that does not cause or that less frequently causes a peak increase due to the leveling control even when a leveling target value has not been set to an appropriate value.

Also, the present invention is not limited to the above described embodiments, and various configurations or embodiments maybe employed without departing from the spirit of the present invention. For example, in the above embodiments, an example has been explained in which the charging control operation is performed on the basis of accumulated received power Ein; however, the control may be performed on the basis of received power. In such a case, the maximum charging amount permitted for the electric cell 11 is equal to the difference between the current received power and the smaller one of the maximum value of the received power and leveling target value x. It is also possible to perform control based on a value resulting from indirectly estimating received power, such as control in which the load power is measured, charged power is calculated from the variation amount of the remaining stored power, and the received power is estimated on the basis of the sum thereof.

It is also possible to combine other countermeasures in order to compensate for a shortage of a remaining charged amount caused by an insufficient number of charging opportunities. In other words, it is also possible, in one of the above embodiments, to perform control in which a power storage device having a higher charging speed is used, charging is performed unconditionally without charge limitations during for example the nighttime or holidays by being in relation to schedule information of the varying load 13. In such a case, it is also possible to perform discharging to use all the power when stored power remains at the end of a daytime time zone so as to save the portion of a fee corresponding to a usage based rate, specifically, the difference in the fees between daytime and nighttime.

When there is an abrupt increase in demand for the varying load 13 in a demand term in a state where the electric cell 11 has a small amount of remaining charged power, the performance of leveling control deteriorates. Accordingly, it is also possible to perform determination on the basis of for example the average power consumed by the varying load 13 and the average power consumed during a peak time so as to prevent the deterioration, caused by an increase in power consumption, in the performance of leveling control by performing discharging. In such a case, it is preferable to create more charging opportunities so as to reliably avoid a situation where the remaining charged amount is not sufficient so that the avoidance of deterioration fails.

In some cases, an error in long-term leveling target value x determination control may be a main factor in causing deterioration in the remaining amount in the electric cell 11, and accordingly the discharging as in S168 in the second embodiment may be performed only when there is an abrupt increase in the power consumed by the varying load 13 in a demand term. An example in which the process of S168 in the second embodiment is performed is effective when a reduction in the remaining amount in the electric cell 11 and an abrupt increase in the power consumed by the varying load 13 occur at a low frequency.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power leveling control device that performs, on the basis of a prescribed target value, leveling on power or a power amount per unit of time supplied by a power supply in a system in which the power supply is connected with a power storage device and a load, the power leveling control device comprising
a processor configured to measure power supplied from the power supply or a power amount in units of time supplied from the power supply, to treat, as a maximum charging amount with which the power storage device is permitted to be charged, a sum of a charging amount with which the power storage device is currently being charged and power or a power amount corresponding to a portion of the power measured or the power amount in the units of time measured that is lower than a smaller value between a maximum value of power supplied from the power supply measured at or after a past first time point or a maximum value of the power amount per unit of time supplied from the power supply measured at or after a past first time and the target value, and to supply power from the power supply to the load and to charge the power storage device within a scope such that the maximum charging amount is not exceeded when the measured power or power amount is equal to or lower than the target value, and to discharge the power storage device so as to supply power to the load when the target value has been exceeded.

2. The power leveling control device according to claim 1, wherein
the processor further
switches between a first state where power is supplied to the load by discharging the power storage device, a second state where power is supplied to the load from the power supply, and a third state where power is supplied to the load from the power supply and the power storage device is charged.

3. The power leveling control device according to claim 2, wherein
the processor further
measures power received from the power supply at and after the first time, and measures accumulated received power in units of time and a received power amount per unit of time by accumulating the measured power; and
switches from the first state to the third state by:
a first switching signal that connects the power supply and the load when the accumulated received power is equal to or smaller than the target value and that disconnects a connection between the power supply and the load when the target value has been exceeded; and
a second switching signal that connects the power storage device with the power supply or the load or any combination thereof when, in a case where the accumulated received power falls below the target value, a power amount of a sum of the accumulated received power and a maximum power amount that a pair of the load and the power storage device receives from the power supply before a time when a present unit of time ends is equal to or smaller than a maximum value of the received power amount per the unit of time measured in a term from the present back to the first time, and when the accumulated received power has exceeded the target value, and that disconnects a connection between the power supply and the power storage device when, in a case where the accumulated received power falls below the target value, a power amount of a sum of the accumulated received power and a maximum power amount that a pair of the load and the power storage device may receive from the power supply before a time when a present unit of time ends exceeds a maximum value of the received power amount per the unit of time measured in a term from the present back to the first time.

4. The power leveling control device according to claim 1, wherein
the first time is a starting time of a leveling control cycle set beforehand as a leveling control cycle in which terms with a high demand for power and with a low demand for power by the load are expected to emerge alternately.

5. The power leveling control device according to claim 4, wherein
a starting time of the leveling cycle is set immediately before the term with a high demand for power.

6. The power leveling control device according to claim 3, wherein
the processor further
determines a maximum received power that may be received from a power supply on the basis of a maximum power consumption of the load, a maximum charged power of the power storage device, lost power of an electric line connected to the load or the power storage device or any combination thereof, or a charging loss of the power storage device or any combination thereof; and
determines, as the maximum power amount, a product of the maximum power and a time between the present and a time when a present unit of time ends.

7. The power leveling control device according to claim 2, wherein
the processor further
measures power received from the power supply at and after the first time, and measuring accumulated received power in units of time and a received power amount per unit of time by accumulating the measured power; and
switches from the first state to the third state by:
a first switching signal that connects the power supply and the load when the accumulated received power is equal to or smaller than the target value and that disconnects a connection between the power supply and the load when the target value has been exceeded; and
a second switching signal that connects the power storage device with the power supply or the load or any combination thereof when, in a case where the accumulated received power falls below the target value, a power amount of a sum of the accumulated received power and a predicted value of a maximum power amount that a pair of the load and the power storage device may receive from the power supply before a time when a present unit of time ends is equal to or smaller than a maximum value of the received power amount per the unit of time measured in a term from the present back to the first time, and when the accumulated received power has exceeded the target value, and that disconnects a connection between the power supply and the power storage device when, in a case where the accumulated received power falls below the target value, a power amount of a sum of the accumulated received power and a predicted value of a maximum power amount that a pair of the load and the power storage device may receive from the power supply before a time when a present unit of time ends exceeds a maximum value of the received power amount per the unit of time measured in a term from the present back to the first time.

8. The power leveling control device according to claim 3, wherein
the first time is a starting time of a leveling control cycle set beforehand as a leveling control cycle in which terms with a high demand for power and with a low demand for power by the load are expected to emerge alternately.

9. The power leveling control device according to claim 8, wherein
a starting time of the leveling cycle is set immediately before the term with a high demand for power.

10. The power leveling control device according to claim 7, wherein
the processor further
determines a maximum received power that may be received from a power supply on the basis of a maximum power consumption of the load, a maximum charged power of the power storage device, lost power of an electric line connected to the load or the power storage device or any combination thereof, or a charging loss of the power storage device or any combination thereof; and
determines, as the predicted value of the maximum power amount, a product of the maximum power and a time between a present and a time when a present unit of time ends.

11. The power leveling control device according to claim 7, wherein
the processor further
determines a maximum power that may be received from the power supply on the basis of a maximum received power amount per the unit of time in the term from the present back to the first time; and
determines, as the predicted value of the maximum power amount, a product of a maximum power that may be received from the power supply and a time between a present and a time when a present unit of time ends.

12. The power leveling control device according to claim 11, wherein
the processor further
determines, as the predicted value of the maximum power amount, a value obtained by dividing the maximum received power amount per the unit of time in the term from the present back to the first time by the unit of time.

13. The power leveling control device according to claim 7, wherein
the processor further
measures the accumulated received power for each prescribed time; and
disconnects a connection between the power supply and the load by the first switching signal, and connects the power storage device to the load by the second switching signal, when it has been determined that a sum of the accumulated received power and a product of a maximum power that may be received from the power supply and the prescribed time exceeds the maximum received power amount per the unit of time in the term from the present back to the first time.

14. A power leveling control method that performs, on the basis of a prescribed target value, leveling on power supplied by a power supply or a power amount per unit of time supplied by a power supply in a system in which the power supply is connected with a power storage device and a load, the power leveling control method comprising:
measuring, by a processor, power supplied from the power supply or a power amount in units of time supplied by a power supply;
treating, by the processor, as a maximum charging amount with which the power storage device is permitted to be charged, a sum of a charging amount with which the power storage device is currently being charged and power or a power amount corresponding to a portion of the power measured or the power amount in the units of time measured that is lower than a smaller value between a maximum value of power supplied from the power supply measured at or after a past first time point or a maximum value of the power amount per unit of time supplied from the power supply measured at or after a past first time and the target value, and having been stored in the storage device; and
supplying, by the processor, power from the power supply to the load and charging the power storage device within a scope such that the maximum charging amount is not exceeded when the measured power or power amount is equal to or lower than the target value, and discharges the power storage device so as to supply power to the load when the target value has been exceeded.

15. A computer-readable recording medium, in a power leveling control device that performs, on the basis of a prescribed target value, leveling on power supplied by a power supply or a power amount per unit of time in a system in which the power supply is connected with a power storage device and a load, having stored therein a program for causing a computer to execute a process comprising:
measuring power supplied from the power supply or a power amount in units of time supplied by a power supply;
treating as a maximum charging amount with which the power storage device is permitted to be charged, a sum of a charging amount with which the power storage device is currently being charged and power or a power amount corresponding to a portion of the power measured or the power amount in the units of time measured that is lower than a smaller value between a maximum value of power supplied from the power supply measured at or after a past first time point or a maximum value of the power amount per unit of time supplied from the power supply measured at or after a past first time and the target value; and
supplying power from the power supply to the load and charging the power storage device within a scope such that the maximum charging amount is not exceeded when the measured power or power amount is equal to or lower than the target value, and discharges the power storage device so as to supply power to the load when the target value has been exceeded.
